(19) United States
(12) Patent Application Publication
(10) Pub. No.: US 2011/0316880 A1
(43) Pub. Date: Dec. 29, 2011

(54) METHOD AND APPARATUS PROVIDING FOR ADAPTATION OF AN AUGMENTATIVE CONTENT FOR OUTPUT AT A LOCATION BASED ON A CONTEXTUAL CHARACTERISTIC

(75) Inventors: Pasi Ojala, Kirkkonummi (FI); Miska Hannuksela, Ruutana (FI)

(73) Assignee: Nokia Corporation

(21) Appl. No.: 12/825,737

(22) Filed: Jun. 29, 2010

(51) Int. Cl. G09G 5/00

(52) U.S. Cl. 345/633

(57) ABSTRACT

An apparatus may include a contextual characteristic determiner configured to determine a contextual characteristic of a location. A sensory device may collect sensed data and location information which is used to determine the contextual characteristic of the location. The sensed data, contextual characteristic and/or location information may be compiled into a database by a database compiler. Further, an ambient content package sharer may request and/or provide sensed data and/or determined contextual characteristics to other devices or the database compiler for inclusion in the database. An augmentative content adaptor may thereby provide for adaptation of an augmentative content for output at the location based on the contextual characteristic. Contextual characteristics may include audible contextual characteristics and visual contextual characteristics.

### TECHNOLOGICAL FIELD

Embodiments of the present invention relate generally to adaptation of an augmentative content for output at a location and, more particularly, relate to an apparatus, method and a computer program product configured to determine a contextual characteristic of a location and provide for adaptation of an augmentative content for output at the location based on the contextual characteristic.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

With the proliferation of mobile terminals, additional functionally has also emerged. In this regard, mobile terminals may access and output visual and audible content for users. Mobile terminals are also now developing virtual reality technologies which may immerse the user into the content through the use of visual displays and audio output. In some variations the user may be able to interact with the virtual reality content. Thus, mobile terminals are enabling new ways of experiencing content.

### BRIEF SUMMARY

A method, apparatus and computer program product are therefore provided that adapt augmentative content for output at a location based on the contextual characteristics of the location.

In an example embodiment, an improved apparatus comprises at least one processor and at least one memory including computer program code, the at least one memory and the computer program code configured to, with the processor, cause the apparatus to determine a contextual characteristic of a location, and provide for adaptation of an augmentative content for output at the location based on the contextual characteristic. In an additional example embodiment a method comprises determining via a processor a contextual characteristic of a location, and providing for adaptation of an augmentative content for output at the location based on the contextual characteristic.

In a further example embodiment a computer program product comprises at least one computer-readable storage medium having computer-executable program code portions stored therein, the computer-executable program code portions comprising program code instructions for determining a contextual characteristic of a location, and program code instructions providing for adaptation of an augmentative content for output at the location based on the contextual characteristic.

In another example embodiment an apparatus comprises means for determining a contextual characteristic of a location, and means providing for adaptation of an augmentative content for output at the location based on the contextual characteristic. Further, the apparatus may comprise means for associating the contextual characteristic with an orientation indicator, and means providing for adaptation of the augmentative content based on the orientation indicator. The apparatus may also comprise means for associating the contextual characteristic with a temporal indicator, and means providing for adaptation of the augmentative content based on the temporal indicator. The apparatus may additionally comprise means for causing an ambient content package to be shared. Also, the apparatus may comprise means providing for adaptation of a visual content characteristic of the augmentative content based on a visual contextual characteristic. Further, the apparatus may comprise means providing for adaptation of an audible content characteristic of the augmentative content based on an audible contextual characteristic. Additionally, the apparatus may comprise means for outputting the augmentative content.

In some embodiments the contextual characteristic may be associated with an orientation indicator and/or a temporal indicator. Thereby, the augmentative content may be adapted base on the orientation indicator and/or the temporal indicator. Further, an ambient content package may be shared. Additionally, a visual content characteristic of the augmentative content may be adapted based on a visual contextual characteristic. Also, an audible content characteristic of the augmentative content may be adapted based on an audible contextual characteristic. Accordingly, embodiments of the present invention may provide for output of augmentative content which more seamlessly adds to the ambient surroundings of the user.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to determine a contextual characteristic of a location and provide for adaptation of an augmentative content for output at the location based on the contextual characteristic according to an example embodiment of the present invention; and

FIG. 3 illustrates a flowchart of the operations performed in determining a contextual characteristic of a location and providing for adaptation of an augmentative content for output at the location based on the contextual characteristic in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

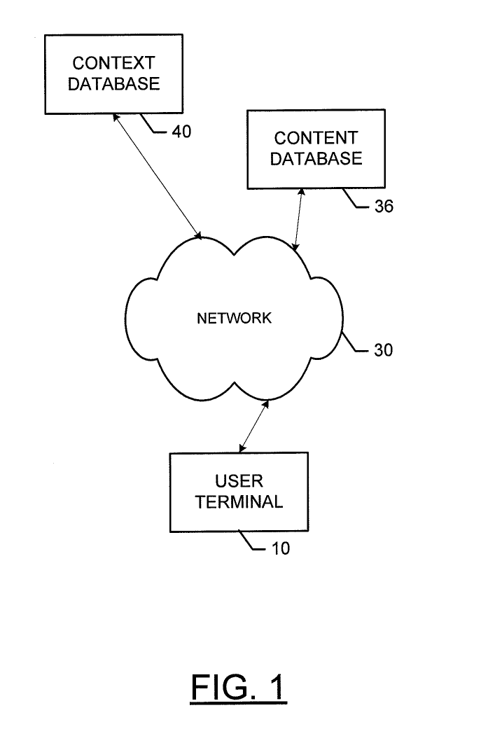

As indicated above, some embodiments of the present invention may be employed in methods, apparatuses and computer program products configured to determine a contextual characteristic of a location and provide for adaptation of an augmentative content for output at the location based on the contextual characteristic. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the mobile terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The system may further comprise a content database 36. In some embodiments the content database 36 may be embodied as a server, server bank or other computer or other computing device or node configured to store and provide augmentative content to the user terminal 10. The content database 36 may have any number of functions or associations with various services. As such, for example, the content database 36 may be a platform such as a dedicated server (or server bank), or the content database may be a backend server associated with one or more other functions or services. Thus, the content database 36 may potentially store and provide a variety of different types of augmentative content. In some embodiments the content database 36 may store and provide commercial and/or non-commercial content. Accordingly, the operations performed by the content database 36 may or may not comprise processing payment in exchange for distributing the augmentative content. In some embodiments payment may be processed by a separate device. Further, although the content database 36 is herein generally described as a server, in some embodiments the content database may be embodied as a portion of the user terminal 10, such an internal module therein, or embodied on the network 30.

As noted above, the content database 36 may store and provide augmentative content to the user terminal 10. Augmentative content, as used herein, refers to content which is intended to augment reality or other content. In this regard, for example, augmentative content may be employed in applications such as augmented reality, ambient telephony, free viewpoint media capture, and rendering service by superimposing the augmentative content on top of the real ambient surroundings or content representative thereof, such as a viewfinder image. Thus, while example embodiments of the system are generally discussed herein in terms of applications involving augmented reality, it should be understood that the system may be employed in various other applications.

The system may additionally comprise a context database 40. In some embodiments the context database 40 may be embodied as a server, server bank or other computer or other computing device or node configured to store and/or determine contextual characteristics. The context database 40 may have any number of functions or associations with various services. As such, for example, the context database 40 may be a platform such as a dedicated server (or server bank), or the context database may be a backend server associated with one or more other functions or services. Thus, the context database 40 may store and/or determine a variety of different types of contextual characteristics and/or provide for adaptation of augmentative content for output at the location based on the contextual characteristic. Further, although the context database 40 is herein generally described as a server, in some embodiments the context database may be embodied as a portion of the user terminal 10, such an internal module therein, or embodied on the network 30. Further, in some embodiments the context database 40 may embody the content database, or vice versa.

As noted above, the context database 40 may store and/or determine contextual characteristics. Contextual characteristics, as used herein, refer to one or more features, elements, or other characteristics which are determined to exist at a given location, such as a location proximate a user and/or the user terminal 10. Contextual characteristics may include audible contextual characteristics and visible contextual characteristics in various embodiments. Thus, by way of example, contextual characteristics may include reverberation, noise level, lighting conditions, light source positions, locations of points of interest, and types and locations of noise sources. Contextual characteristics may also classify the location into various categories, such as a meeting room, restaurant, indoor location, outdoor location, etcetera. Therefore, contextual characteristics may include a wide variety of information relating to a given location and the examples provided herein should not be considered to be limiting.

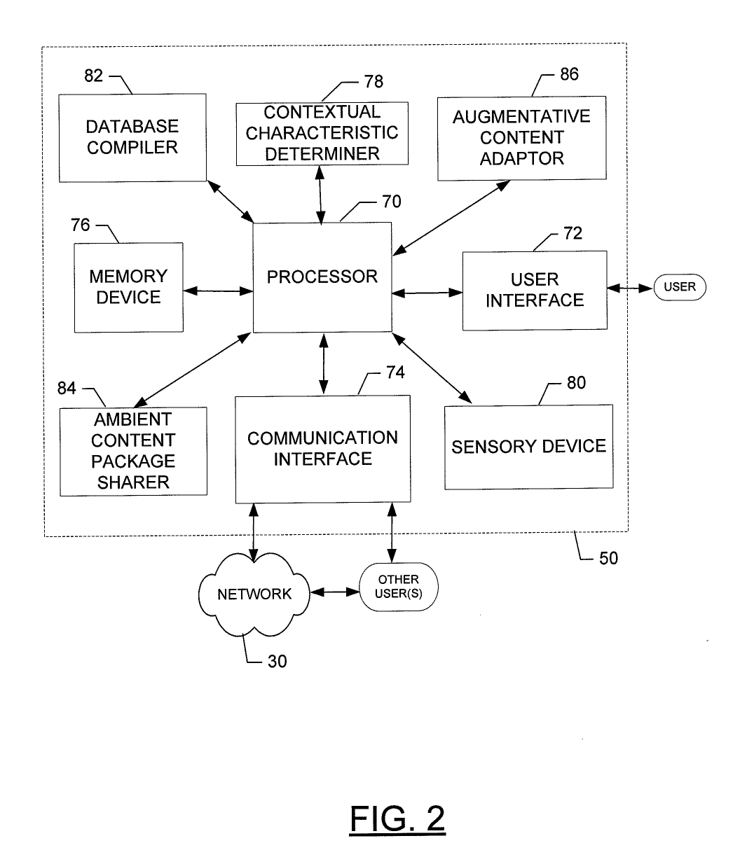

In an example embodiment, an apparatus 50 is provided that may be employed by devices performing example embodiments of the present invention. The apparatus 50 may be embodied, for example, as any device hosting, including, controlling or otherwise comprising the user terminal 10. However, embodiments may also be embodied on a plurality of other devices such as for example where instances of the apparatus 50 may be embodied on the network 30, the content database 36, and/or the context database 40. As such, the apparatus 50 of FIG. 2 is merely an example and may include more, or in some cases less, than the components shown in FIG. 2.

With further regard to FIG. 2, the apparatus 50 may be configured to determine a contextual characteristic of a location and provide for adaptation of an augmentative content for output at the location based on the contextual characteristic. Note that, location, as used herein, may refer not only to the precise location of the user and/or mobile terminal 10, but also to a region or area. In this regard, for example, if the user is walking or driving with the apparatus 50, there may be change in the actual coordinates of the user and the apparatus between where the contextual characteristic is determined and the augmentative content is outputted. However, within the meaning of the term location as used herein, the location remains the same.

The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, a ringer or other input/output mechanisms. In some embodiments the speaker may comprise headphones configured to output multiple channels of audio while allowing the user to also hear ambient noises.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor may be configured to control one or more functions of one or more elements of the user interface 72 through computer program instructions (for example, software and/or firmware) stored on a memory accessible to the processor (for example, memory device 76, and/or the like). In some embodiments the user interface 72 may comprise a display configured to output augmentative content. For example, in some embodiments the display may comprise a transparent or translucent display, such as glasses, through which a user may also view the ambient surroundings.

In some embodiments the apparatus 50 may further include a contextual characteristic determiner 78. The processor 70 may be embodied as, include or otherwise control the contextual characteristic determiner 78. The contextual characteristic determiner 78 may be configured to determine a contextual characteristic of a location. In this regard, various examples of contextual characteristics are described above. Determining contextual characteristics may in some embodiments involve capturing data with the apparatus 50 from which the contextual characteristics may be determined. For example, this may be the case when all or a part of the apparatus 50 is embodied on the user terminal 10. In other embodiments the apparatus 50 may not directly capture the sensed data from which the contextual characteristics are determined. For example, this may be the case when all or a part of the apparatus 50 is embodied in the context database 40 in which the sensed data may, for example, be sensed by the user terminal 10, and then the context database may determine the contextual characteristics from the sensed data. Regardless of whether or not the apparatus 50 captures the sensed data directly, the contextual characteristic determiner 78 may analyze the sensed data to determine various contextual characteristics of the location at which the sensed data was captured. Examples of methods of determining contextual characteristics are described below.

As noted above, determining contextual characteristics may in some embodiments involve sensing the data from which the contextual characteristics are determined with the apparatus 50. In this regard, the apparatus 50 may further include a sensory device 80. The processor 70 may be embodied as, include or otherwise control the sensory device 80. The sensory device 80 may comprise an optical sensor such as a camera, an audio device such as a microphone, and/or various other sensors configured to sense data at a location. In some embodiments the sensory device 80 may comprise a portion of the user interface 72. With regard to microphones in particular, an array of two or microphones may be used to determine the type and location of a source of noise, as will be discussed below. The sensory device 80 may also sense and record a temporal indicator indicating the time at which the sensory data is recorded.

Examples of location estimation are as follows: The basic direction of arrival estimation may be conducted using a microphone array consisting of at least two microphones. Typically, the output of the array is the sum signal of all microphones. Turning the array and detecting the direction that provides the highest amount of energy of the signal of interest is the most straightforward method to estimating the direction of arrival. Steering of the array, i.e. turning the array towards the point of interest is typically implemented, instead of physically turning the device, using the sound wave interference phenomena by adjusting the microphone delay lines. For example, the two microphone array may be aligned off the perpendicular axis of the microphones by delaying the other microphone input signal by certain amount before summing them up. The time delay providing the maximum energy of the sum signal of interest corresponds to the direction of arrival.

When the distance between the microphones, required time delay and speech of sound is known, determining the direction of arrival of the sound source may involve trigonometry. A more straightforward method to estimate the direction of arrival is simply detecting the amplitude differences of microphone signals and applying corresponding panning laws.

When the inter channel time and level difference parameterization is available, the direction of arrival estimation can be conducted for each sub-band by first converting the time difference cue into a reference direction of arrival cue φ by solving the equation

τ=(|x|sin(φ))/c, (1)

where |x| is the distance between the microphones and c is the speed of sound.

Alternatively, the inter channel level cue can be applied. The direction of arrival cue φ is determined using, for example, the traditional panning equation

$$sin φ = \frac{{l}_{1} - {l}_{2}}{{l}_{1} + {l}_{2}} , \qquad ( 2 )$$

where lᵢ=xᵢ(n)^{T}xᵢ(n) of channel i.

In some embodiments the sensory device 80 may include a GPS module which is configured to determine the location at which the sensed data is recorded. Alternatively or additionally the location of the apparatus 50 may be determined through other methods such as by determining the cellular identification of a cellular network on which the apparatus is operating, triangulation using cell towers, known landmarks, or beacon signals, visual localization in conjunction with comparison to known map data, etcetera. Visual localization may include extracting feature points from a captured image and matching the feature points to known feature points in three-dimensional models of the surroundings. Further, the above-described methods of determining the direction of sources of sound may be employed to determine the location of the apparatus 50 in some embodiments wherein the sensory device 80 senses sources of sound having known locations. Additionally, microphones from multiple devices could be used to determine location in a collaborative manner. Also, orientation of the apparatus 50 and/or the user may be determined by the sensory device 80 using compass information, head tracking methods, etcetera. Thereby the apparatus 50 may store an orientation indicator indicating the orientation of the apparatus 50 and/or the user at the time of capturing the sensed data. Accordingly, the sensory device 80 may both capture sensed data and location information which corresponds to the sensed data in various embodiments.

In some embodiments the apparatus 50 may make use of the sensed data and/or the determined contextual characteristics of the location (as will be described below) in real time, and hence the sensed data and/or the determined contextual characteristics may not in all embodiments need to be retained. However, in some embodiments the apparatus 50 may compile sensed data and/or the contextual characteristics with the corresponding location information into a database. This may for example occur when the apparatus 50 is included in or is otherwise in communication with the context database 40. Accordingly, the apparatus 50 may include a database compiler 82. The processor 70 may be embodied as, include or otherwise control the database compiler 82. The database compiler may compile the sensory data and/or determined contextual characteristics into a database which is sortable based on location. The database may also be sortable based on time in embodiments in which the database compiler 82 collects temporal indicators indicating the time at which the data is recorded. The database compiler 82 may also associate the sensed data and/or the contextual characteristics with orientation indicators and temporal indicators in some embodiments. Thus, the database may be sortable based on orientation indicators and temporal indicators for each location. Thereby, the database compiler 82 may build a database of information which may provide for adaptation of augmentative content for output at the location based on the contextual characteristic. For example, the database may be made available to a device which outputs the content as described below.

In order for the database compiler 82 to create a database which includes a large amount of useable information, the apparatus 50 may in some embodiments comprise an ambient content package sharer 84. The processor 70 may be embodied as, include or otherwise control the ambient content package sharer 84. The ambient content package sharer 84 may send and/or receive requests to capture and/or share an ambient content package comprising sensed data and/or determined contextual characteristics for a location. In this regard, for example, if the database as compiled by the database compiler 82 lacks data for a certain location or the existing data may need further refinement and confirmation, the ambient content package sharer 84 may send a request to another device to collect sensory data at that location and/or determine contextual characteristics of the location and share the ambient content package with the apparatus 50.

In this regard, for example, a plurality of devices such as the user terminal 10 may be configured to share location data with the context database 40. Thereby when, for example, the user terminal 10 travels to a location for which the context database 40 is missing data, the context database 40 may request that the user terminal collect sensory data and/or determine contextual characteristics of the location. Thereby, the user terminal 10 may send the context database 40 an ambient content package comprising sensory data and/or determined contextual characteristics of the location, and hence the context database may add the ambient content package to the database. However, note that is just one example of an embodiment in which the ambient content package sharer 84 may be used. In various other embodiments multiple devices such as the user terminal 10 may form a peer-to-peer network whereby ambient content package sharers 84 in the various devices share data and information directly or through the network 30 without use of the context database 40. Further, the contribution of the sensed data and contextual characteristics may be entirely voluntary in some embodiments, and for example, require user approval to fulfill the request. Further, in some embodiments the database compiler 82 may additionally or alternatively build the database using publicly available pictures and other data which includes location information.

As noted above, the contextual characteristics may be stored in a database using the database compiler 82 and then retrieved when needed or instead the contextual characteristics may be determined in real time without being retrieved from storage in a database. Regardless, the apparatus 50 may include an augmentative content adaptor 86 which is configured to provide for adaptation of an augmentative content for output at the location based on the contextual characteristics. By way of example, the augmentative content may be provided to the apparatus 50 by the content database 36 in some embodiments. The processor 70 may be embodied as, include or otherwise control the augmentative content adaptor 86. The augmentative content adaptor 86 may adapt augmentative content in a variety of manners in various embodiments. As described above, augmentative content, as used herein, refers to content which is intended to augment other content or reality. Thus, the augmentative content adaptor 86 may adapt the augmentative content to seamlessly fit in with the content or ambient reality to which augmentative content is added.

In this regard, for example, the augmentative content adaptor 86 may provide for adaptation of a visual content characteristic of the augmentative content based on a visual contextual characteristic. For example, the augmentative content adaptor 86 may adapt the rendering layout of the augmentative content in terms of scale, perspective, or other geometric characteristic. Thereby, for example, when the augmentative content comprises a graphic in the form of an arrow which is intended to point out an advertisement in the user's vicinity, the arrow may be sized based on the perceived size of the advertisement from the user's vantage point. As an alternative example, the augmentative content may comprise a graphic which is superimposed over the advertisement. For example, the augmentative content may comprise a graphic which is displayed so as to appear as if it posted on a billboard in the user's vicinity. In this regard, the graphic could be sized and shaped like the billboard. However, various other visual content characteristics may also be adapted. For example, the augmentative content may include multiple possible views, and the augmentative content adaptor 86 may select the view. Further, the augmentative content adaptor 86 may modify the rendering of the augmentative content in terms of lightness, color tones, tone mapping, etcetera depending on the lighting at the location and other visual contextual characteristics. For example, a virtual neon sign rendered on a screen as an augmented content could be illuminated in low lighting conditions and not illuminated in bright daylight.

The augmentative content adaptor 86 may further provide for adaptation of an audible content characteristic of the augmentative content based on an audible contextual characteristic. For example, the augmentative content adaptor 86 may adjust the volume of the augmentative content based on the level of ambient noise or match the natural reverberations which occur at that location. Reverberation may be estimated, for example, by detecting transients such as a door slamming and foot steps, and measuring the corresponding impulse responses. In some example embodiments the augmentative content adaptor 86 may adapt the audible content characteristics to cancel out nearby sound sources such as air vents, escalators, loudspeakers, etc. In one example embodiment the augmentative content adaptor 86 may adapt the content so that it sounds like it is coming from a speaker which is visible to the user. Thereby, the audible content characteristics of the augmentative content may be adapted to fit the ambient environment or standout from the ambient environment, as desired.

However, the audible and visual contextual characteristics for a given location may vary in some instances. In this regard, as noted above, the apparatus 50 may in some embodiments record a temporal indicator indicating the time at which the sensed data is captured. Thus, for example, an outdoor location may have extremely different lighting conditions depending on the time of day. Therefore, in some embodiments the augmentative content adaptor 86 may adapt the augmentative content based on the temporal indicator.

Further, the audible and visual contextual characteristics of a location may also vary depending on the orientation of the apparatus 50 and user. For example, if the user is looking in a northerly direction, the visual contextual characteristics of the location may be completely different from the visual contextual characteristics of the location when looking in a southerly direction. Therefore, the augmentative content adaptor 86 may provide for adaptation of the augmentative content based on an orientation indicator which may be associated with the contextual characteristics as described above.

Thereby, in various embodiments the apparatus 50 may determine a contextual characteristic of a location, provide for adaptation of an augmentative content for output at the location based on the contextual characteristic, and provide for output of the augmentative content at the location. However, as noted above, the apparatus 50 may be embodied on one or more of the user terminal 10, the context database 40, and the content database 36. Thus, the apparatus 50 may not include all of the elements described above and/or the apparatus may be embodied in multiple parts of the system.

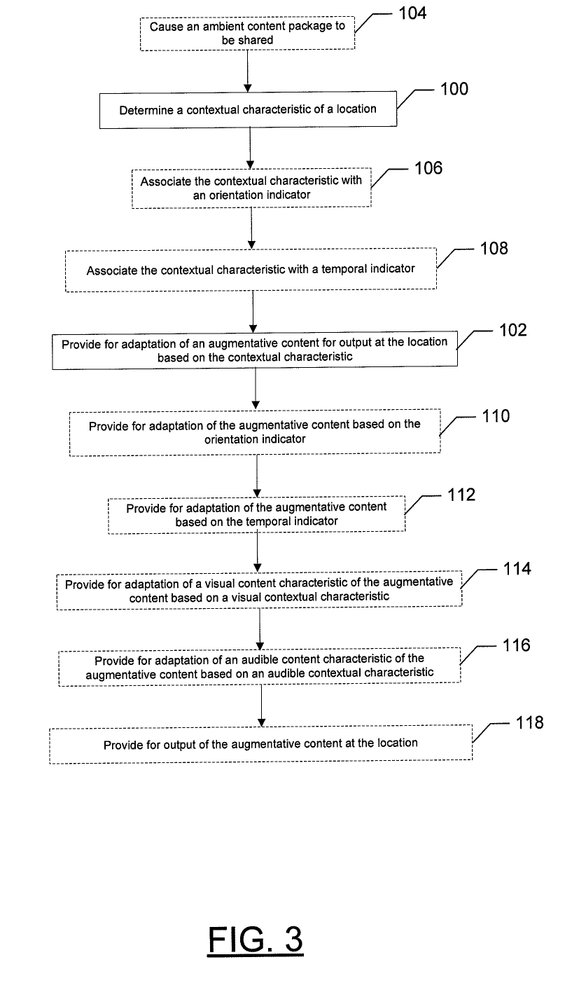

In terms of methods associated with embodiments of the present invention, the above-described apparatus 50 or other embodiments of apparatuses may be employed. In this regard, FIG. 3 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method includes determining a contextual characteristic of a location at operation 100. Further, the method may include providing for adaptation of an augmentative content for output at the location based on the contextual characteristic at operation 102.

In some embodiments, certain ones of the above-described operations (as illustrated in solid lines in FIG. 3) may be modified or further amplified. In some embodiments additional operations may also be included (some examples of which are shown in dashed lines in FIG. 3). It should be appreciated that each of the modifications, optional additions or amplifications may be included with the above-described operations (100-102) either alone or in combination with any others among the features described herein. As such, each of the other operations as will be described herein may be combinable with the above-described operations (100-102) either alone or with one, more than one, or all of the additional operations in any combination.

For example, the method may further comprise sharing an ambient content package at operation 104. As described above, sharing may include requesting or providing the ambient content package in response to a request. Further, the content package may include sensed data and/or determined contextual characteristics of the location in some embodiments. Accordingly, in some embodiments the sensed data provided as part of the ambient content package may be used to determine the contextual characteristic of the location at operation 100. The method may additionally include associating the contextual characteristic with an orientation indicator at operation 106 and/or associating the contextual characteristic with a temporal indicator at operation 108. Accordingly, the method may comprise providing for adaptation of the augmentative content at the location based on the orientation indicator at operation 110 and/or providing for adaptation of the augmentative content based on the temporal indicator at operation 112.

Further, the method may comprise providing for adaptation of a visual content characteristic of the augmentative content based on a visual contextual characteristic at operation 114. The method may also include providing for adaptation of an audible content characteristic of the augmentative content based on an audible contextual characteristic at operation 116. Thus, the adaptation of the augmentative content may be based on one or both of audible and visual contextual characteristics of the location. Additionally, the method may comprise providing for output of the augmentative content at the location at operation 118.

In an example embodiment, an apparatus for performing the method of FIG. 3 and other methods described above may comprise a processor (for example, the processor 70) configured to perform some or each of the operations (100-118) described above. The processor may, for example, be configured to perform the operations (100-118) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-118 may comprise, for example, the processor 70, the user interface 72, the communication interface 74, the contextual characteristic determiner 78, the sensory device 80, the database compiler 82, the ambient content package sharer 84 and/or the augmentative content adaptor 86, as described above. However, the above-described portions of the apparatus 50 as they relate to the operations of the method illustrated in FIG. 3 are merely examples, and it should be understood that various other embodiments may be possible.

In some embodiments the operation 100 of determining a contextual characteristic of a location may be conducted by means for determining a contextual characteristic of a location, such as the contextual characteristic determiner 78, sensory device 80, and/or the processor 70. Further, the operation 102 of providing for adaptation of an augmentative content for output at the location based on the contextual characteristic may be conducted by means providing for adaptation of an augmentative content, such as the augmentative content adaptor 86, and/or the processor 70. Additionally, the operation 104 of sharing an ambient content package may be conducted by means for causing an ambient content package to be shared, such as the communication interface 74, the ambient content package sharer 84, and/or the processor 70.

Further, the operation 106 of associating the contextual characteristic with an orientation indicator and the operation 108 of associating the contextual characteristic with a temporal indicator may be conducted by means for associating the contextual characteristic with an orientation indicator or means for associating the contextual characteristic with a temporal indicator, respectively, such as the database compiler 82, and/or the processor 70. Also, the operation 110 of providing for adaptation of the augmentative content based on the orientation indicator and the operation 112 of providing for adaptation of the augmentative content based on the temporal indicator may be conducted by means providing for adaptation of the augmentative content based on the temporal indicator or means providing for adaptation of the augmentative content based on the orientation indicator, respectively, such as the augmentative content adaptor 86, and/or the processor 70. Additionally, the operation 114 of providing for adaptation of a visual content characteristic of the augmentative content based on a visual contextual characteristic and the operation 116 of providing for adaptation of an audible content characteristic of the augmentative content based on an audible contextual characteristic may also be conducted by means providing for adaptation of a visual content characteristic of the augmentative content or means providing for adaptation of an audible content characteristic of the augmentative content, respectively, such as the augmentative content adaptor 86, and/or the processor 70. Further, the operation 118 of providing for output of the augmentative content at the location may be conducted by means for outputting the augmentative content, such as the user interface 72, and/or the processor 70. In this regard, as described above, the user interface 72 may include specialized displays such as near-to-eye displays, see-through glasses and/or hear-through headphones which are capable of outputting augmentative content which augments the ambient surroundings of the user and/or other content.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the processor, cause the apparatus to:
determine a contextual characteristic of a location; and
provide for adaptation of an augmentative content for output at the location based on the contextual characteristic.

2. The apparatus of claim 1, further configured to associate the contextual characteristic with an orientation indicator; and
provide for adaptation of the augmentative content based on the orientation indicator.

3. The apparatus of claim 1, further configured to associate the contextual characteristic with a temporal indicator; and
provide for adaptation of the augmentative content based on the temporal indicator.

4. The apparatus of claim 1, further configured to cause an ambient content package to be shared.

5. The apparatus of claim 1, further configured to provide for adaptation of a visual content characteristic of the augmentative content based on a visual contextual characteristic.

6. The apparatus of claim 1, further configured to provide for adaptation of an audible content characteristic of the augmentative content based on an audible contextual characteristic.

7. The apparatus of claim 1, further comprising user interface circuitry configured to output the augmentative content through use of a display.

8. A method comprising:
determining a contextual characteristic of a location; and
providing for adaptation of an augmentative content for output at the location based on the contextual characteristic via a processor.

9. The method of claim 8, further comprising providing for output of the augmentative content at the location.

10. The method of claim 8, further comprising associating the contextual characteristic with an orientation indicator; and
providing for adaptation of the augmentative content based on the orientation indicator.

11. The method of claim 8, further comprising associating the contextual characteristic with a temporal indicator; and
providing for adaptation of the augmentative content based on the temporal indicator.

12. The method of claim 8, further comprising causing an ambient content package to be shared.

13. The method of claim 8, further comprising providing for adaptation of a visual content characteristic of the augmentative content based on a visual contextual characteristic.

14. The method of claim 8, further comprising providing for adaptation of an audible content characteristic of the augmentative content based on an audible contextual characteristic.

15. A computer program product comprising at least one computer-readable storage medium having computer-executable program code portions stored therein, the computer-executable program code portions comprising:
program code instructions for determining a contextual characteristic of a location; and
program code instructions providing for adaptation of an augmentative content for output at the location based on the contextual characteristic.

16. The computer program product of claim 15, further comprising program code instructions providing for output of the augmentative content at the location.

17. The computer program product of claim 15, further comprising program code instructions for associating the contextual characteristic with an orientation indicator; and
program code instructions providing for adaptation of the augmentative content based on the orientation indicator.

18. The computer program product of claim 15, further comprising program code instructions for associating the contextual characteristic with a temporal indicator; and
program code instructions providing for adaptation of the augmentative content based on the temporal indicator.

19. The computer program product of claim 15, further comprising program code instructions for causing an ambient content package to be shared.

20. The computer program product of claim 15, further comprising program code instructions providing for adaptation of an audible content characteristic of the augmentative content based on an audible contextual characteristic.
